(19) United States
(12) Patent Application Publication
(10) Pub. No.: US 2003/0022973 A1
(43) Pub. Date: Jan. 30, 2003

(54) Moisture cured polyurethane hot melt adhesives with reactive tackifiers

(76) Inventors: Ju-Ming Hung, Yardley, PA (US); James W. Nowicki, Hopewell, NJ (US)

Correspondence Address: Cynthia L. foulke, National Starch and Chemical Company, P.O. Box 6500, Bridgewater, NJ, 08807-0500, US

(21) Appl. No.: 09/834,520

(22) Filed: Apr. 13, 2001

(51) Int. Cl. C08K 3/00; C08L 67/00

(52) U.S. Cl. 524/270; 524/539

(57) ABSTRACT

This invention relates to hot melt polyurethane adhesive or sealant compositions which are solid at room temperature. The adhesive or sealant compositions comprise a hot melt polyurethane adhesive or sealant composition comprising (a) a urethane prepolymer; (b) a polyester resin; and (c) a reactive tackifier represented by the formula:

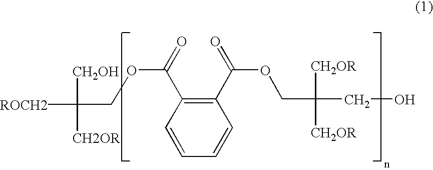

wherein R is selected from the group consisting of tall oils, abietic acid, isomeric mixtures of abietic acid, and mixtures thereof, and n is an integer from 1 to about 4.

### FIELD OF THE INVENTION

This invention relates to hot melt polyurethane adhesive or sealant compositions.

### BACKGROUND OF THE INVENTION

Hot melt adhesives are 100% solid materials which do not contain or require any solvents and are solid at room temperature. On application of heat, the hot melt adhesive melts to a liquid or fluid state in which form it is applied to a substrate. On cooling, the hot melt adhesive regains its solid form, cures by a chemical crosslinking reaction, and thereby gains its cohesive strength. hot melt adhesives have been prepared using specific materials such as polyurethanes.

Reactive hot melts are one-component, 100% solid, solvent-free urethane prepolymers. Unlike conventional hot melts that can be repeatedly heated from solid state and flowed to a liquid form, the reactive hot melt behaves as a thermoset and goes through an irreversible chemical reaction once dispensed in the presence of ambient moisture. The reactive hot melts are isocyanate terminated prepolymers that react with surface or ambient moisture in order to chain-extend, forming novel polyurethane polymers.

U.S. Pat. No. 3,931,077 (Uchigaki et al.) discloses a reactive hot melt-type adhesive composition comprising a reactive compound, a thermoplastic resin, and a tackifier. The reactive compound is a urethane prepolymer having terminal isocyanate groups at both ends resulting from the addition polymerization of a diisocyanate and a diol. The thermoplastic resin is an ethylene-vinylacetate co-polymer, an ethylene-acrylic acid copolymer, an ethyleneacrylate copolymer, an atactic polypropylene, or a polyethyleneterephthalate linear polymer. The tackifier is a hydrogenated abietic acid-type rosin or ester having its double bonds removed by hydrogenation in whole or in part, or a terpene-phenol copolymer of a mono- or diterpene.

U.S. Pat. No. 4,585,819 (Reischle et al.) discloses a fusion adhesive which comprises 20-90% by weight isocyanate prepolymer, and 5-50% by weight of a lower molecular weight synthetic resin selected from the group consisting of ketone resins, hydrogenated products of acetophenone, and condensation resins.

U.S. Pat. No. 4,775,719 (Markevka et al. '719) discloses a hot melt thermosetting urethane adhesive composition that can be extruded as a hot melt adhesive to form an initially high green strength hot melt bond and can moisture cure to a rigid moisture cure polyurethane bond. The urethane adhesive composition comprises (a) a film-forming thermoplastic ethylene-vinyl monomer copolymer which is a vinyl monomer of an acrylate monomer or a vinyl ester of a carboxylic acid compound; (b) a liquid polyurethane prepolymer composition; (c) a phenol-free, aromatic or aliphatic-aromatic polymer tackifier comprising a monomer selected from the group consisting of a C₄₋₆ diene, a styrenic monomer, an indene monomer, and dicyclopentadiene; and (d) an antioxidant.

U.S. Pat. No. 4,808,255 (Markevka et al. '255) discloses a reactive hot melt urethane adhesive composition having extended pot stability, bond heat stability, green strength and cured bond strength. The urethane adhesive composition comprises (a) a urethane prepolymer composition; (b) a structural thermoplastic ethylene vinyl monomer copolymer composition; and (c) a compatible aliphatic, aromatic or aliphatic-aromatic tackifying resin.

U.S. Pat. No. 5,021,507 (Stanley et al.) discloses the incorporation into a conventional polyurethane hot melt adhesive of low molecular weight polymers formed from ethylenically unsaturated monomers containing no reactive hydrogen. The polymers provide an improvement in cohesive and adhesive strength and assist in forming bonds with some of the more difficult to adhere substrates. In order to incorporate the low molecular weight polymer into the polyurethane, the respective monomers are polymerized within the urethane prepolymer or an already polymerized low molecular weight polymer is added into the urethane prepolymer. Typical monomers useful include acrylic monomers such as the C1 to C12 esters of acrylic or methacrylic acid as well as ethylenically unsaturated monomers containing moisture reactive functional groups such as silane or reactive isocyanate. Typical low molecular weight polymers are Elvacite 2013, a 64% butylmethacrylate/36% methylmethacrylate copolymer having an I.V. of 0.2.

U.S. Pat. No. 5,189,096 (Boutillier et al.) discloses a cross-linkable hot-melt adhesive composition comprising the prepolymerizate of an hydroxylated ethylene/vinyl acetate copolymer with a stoichiometric excess of a polyisocyanate. The prepolymerizate contains an effective crosslinkable amount of free isocyanate functional groups.

While the class of adhesives in the above disclosures describe the preparation of a number of adhesive compositions, there continues to be a need for reactive hot melt compositions having increased heat and tensile properties.

### SUMMARY OF THE INVENTION

The present invention pertains to a hot melt polyurethane adhesive or sealant composition comprising:

(a) a urethane prepolymer;

(b) a polyester resin; and

(c) a reactive tackifier represented by the formula:

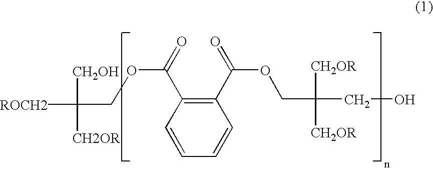

wherein R is selected from the group consisting of tall oils, abietic acid, isomeric mixtures of abietic acid, and mixtures thereof, and n is an integer from 1 to about 4.

The present invention also pertains to an article of manufacture comprising the hot melt polyurethane adhesive or sealant composition.

### DETAILED DESCRIPTION OF THE INVENTION

The present invention pertains to hot melt polyurethane adhesive or sealant compositions which are solid at room temperature. The polyurethane adhesive or sealant compositions are based on the use of a polyisocyanate, at least one or more reactive tackifiers, together with at least one polyester diol. The reactive hot melt adhesives demonstrate combined properties of lower viscosity, longer open time, better initial peel strength and lap shear strength development than formulations not using this combination of ingredients.

Applicant has found that the addition of urethane prepolymers to low molecular weight polymers formed from ethylenically unsaturated monomers and reactive tackifiers provide hot melt adhesives and gasketing compositions which are solid at room temperature, which can be readily coated at a viscosity of 3000 to 50,000 cps. at 120° C. without the need for additional plasticizers, and which have improved initial cohesive strength as well as improved strength after aging of the cured bond. Moreover, the adhesives exhibit these improved properties on a wide range of substrates including difficult to bond substrates.

In addition, applicant has found that the heat resistance of the hot melt polyurethane adhesive or sealant compositions of the present invention may be even further improved by utilizing an ethylenically unsaturated monomer which contains moisture reactive functional crosslinking groups. The resultant hot melt adhesive, upon curing, produces an adhesive consisting of a crosslinked polyurethane and a non-crosslinked ethylenically unsaturated polymer, i.e., a semi-interpenetrating network (IPN) adhesive. As such, these adhesive compositions are particularly adapted for use in structural applications including those where epoxy adhesives are primarily employed.

As set out above, the hot melt polyurethane adhesive or sealant composition comprises: (a) a urethane prepolymer; (b) a polyester resin; and (c) a reactive tackifier represented by the formula:

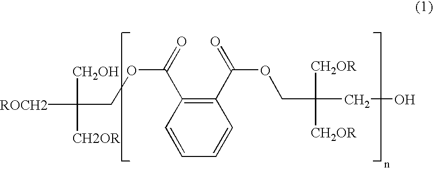

In Formula (1), R is selected from the group consisting of tall oils, abietic acid, isomeric mixtures of abietic acid, and mixtures thereof, and n is an integer from 1 to about 4.

The urethane prepolymers (a) are those conventionally used in the production of polyurethane hot melt adhesive compositions. Most commonly, the prepolymer is prepared by the condensation polymerization of a polyisocyanate with a polyol, most preferably the polymerization of a diisocyanate with a diol. The polyols used include polyhydroxy ethers (substituted or unsubstituted polyalkylene ether glycols or polyhydroxy polyalkylene ethers), polyhydroxy polyesters, the ethylene or propylene oxide adducts of polyols, and the monosubstituted esters of glycerol.

In addition, the urethane prepolymers may be prepared by the reaction of a polyisocyanate with a polyamino or a polymercapto-containing compound such as diamino polypropylene glycol or diamino polyethylene glycol or polythioethers such as the condensation products of thiodiglycol either alone or in combination with other glycols such as ethylene glycol, 1,2-propylene glycol or with other polyhydroxy compounds disclosed above.

Further, small amounts of low molecular weight dihydroxy, diamino, or amino hydroxy compounds may be used such as saturated and unsaturated glycols, e.g., ethylene glycol or condensates thereof such as diethylene glycol, triethylene glycol, and the like; ethylene diamine, hexamethylene diamine and the like; ethanolamine, propanolamine, N-methyidiethanolamine and the like

Any suitable organic polyisocyanate may be used such as, for example, ethylene diisocyanate; ethylidene diisocyanate; propylene diisocyanate; butylene diisocyanate; hexamethylene diisocyanate; toluene diisocyanate; cyclopentylene-1,3,-diisocyanate; 3-isocyanatomethyl-3,5,5-trimethylcyclohexyl isocyanate; 3-isocyanatomethyl-3,5,5-trimethylcyclohexyl isocyanate cyanurate; cyclohexylene-1,4-diisocyanate; cyclohexylene-1,2-diisocyanate; 4,4′-diphenylmethanediisocyanate; 2,2-diphenylpropane-4,4′-diisocyanate, p-phenylene diisocyanate; m-phenylene diisocyanate; xylylene diisocyanate; 1,4-naphthylene diisocyanate, 1,5-naphthylenediisocyanate; diphenyl-4,4′-disocyanate; azobenzene-4,4′-diisocyanate; diphenylsulphone-4,4′-diisocyanate; dichlorohexamethylene diisocyanate; furfurylidene diisocyanate; 1-chlorobenzene-2,4-diisocyanate; 4,4′,4″-triisocyanatotriphenylmethane; 1,3,5-triisocyanato-benzene; 2,4,6-triisocyanato-toluene and 4,4′-dimethyldiphenylmethane-2,2′,5,5-tetraisocyanate, and the like.

The polyisocyanate and polyol, polyamino or polymercapto components are combined in proportions so as to yield a urethane prepolymer characterized by an isocyanate content (i.e., %NCO) of from about 0.25% to about 25%, preferably from about 5% to about 20%, and most preferably from about 8% to about 15%. In addition, the ratio of isocyanate equivalents to hydroxyl, amino or mercapto equivalents (known as the isocyanate index) should be greater than 1, preferably no more than about 3. By maintaining the low isocyanate index, the level of free isocyanate monomer content in the final hot melt adhesive composition can be reduced to less than about 4%. The presence of higher levels of free isocyanate has a detrimental effect on a hot melt formulation since it causes toxic fumes to be released when the adhesive is heated to application temperature. The higher levels of free isocyanate may also cause reduction in viscosity and poorer initial bond strength of the adhesive. The precise amount of the polyisocyanate used in the polymerization will depend on the equivalent weight and amount of the non-isocyanate components, and the particular polyisocyanate employed. In general, the amount of the polyisocyanate needed to achieve the isocyanate content will vary from about 5 to about 35% of the final prepolymer.

The polyester resin (b) may be any of a group of thermosetting synthetic resins which are polycondensation products of dicarboxylic acids and dihydroxy alcohols. Polyester resins are a special type of alkyd resins, but unlike other types of resins, they are not usually modified with fatty acids or drying oils. An important characteristic of polyester resins is that they have the ability, when catalyzed, to cure or harden at room temperature under little or no pressure. The polyester resins may be saturated or unsaturated. Many polyester resins contain ethylenic unsaturation which is generally introduced through the unsaturated acids. The unsaturated polyesters are usually cross-linked through their double bonds with a compatible monomer also containing ethylenic unsaturation and thus become thermosetting. Styrene and diallyl phthalate are common cross-linking agents. Illustrative nonlimiting saturated dicarboxylic acids which may be present in the polyester resins are C₄-C₁₂ dicarboxylic acids such as adipic acid (1, 2-butanedicarboxylic acid). Illustrative nonlimiting unsaturated dicarboxylic acids which may be present in the polyester resins are maleic acid and fumaric acid. Illustrative nonlimiting aromatic dicarboxylic acids which may be present in the polyester resins are phthalic acid (1, 2-benzenedicarboxylic acid), isophthalic acid (1, 3-benzenedicarboxylic acid), and terephthalic acid (1, 4-benzenedicarboxylic acid). The function of saturated acids is to reduce the amount of unsaturation in the final resin making the resin tougher and more flexible. The acid anhydrides of the dicarboxylic acids may also be used. Illustrative nonlimiting dihydroxy alcohols which may be present in the polyester resins are C₆-C₁₂ dihydroxy alcohols such as ethylene glycol, propylene glycol, diethylene glycol, dipropylene glycol, hexamethylene glycol (hexanediol), and dodecanediol.

Preferably, the polyester resin (b) is a polycondensation product of a C₄-C₁₂ dicarboxylic acid and a C₆-C₁₂ dihydroxy alcohol, wherein the C₄-C₁₂ dicarboxylic acid is selected from the group consisting of adipic acid, maleic acid, fumaric acid, phthalic acid, isophthalic acid, and terephthalic acid, and the C₆-C₁₂ dihydroxy alcohol is selected from the group consisting of ethylene glycol, propylene glycol, diethylene glycol, dipropylene glycol, hexamethylene glycol, and dodecanediol.

The reactive tackifier (c) may be represented by the formula (1):

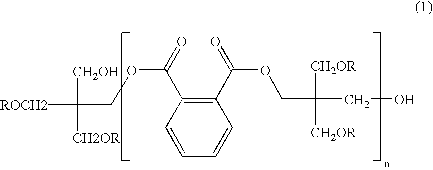

In Formula (1), R may be selected from the group consisting of tall oils, abietic acid, isomeric mixtures of abietic acid, and mixtures thereof. In one embodiment, R in the reactive tackifier (c) is tall oil. In another embodiment, R in the reactive tackifier (c) is abietic acid. In yet another embodiment, R in the reactive tackifier (c) is an isomeric mixture of abietic acid.

Tall oil (tall oil fatty acids, tallol, talleol, liquid rosin, Acintol C) is a mixture of rosin acids, fatty acids, and other materials obtained by acid treatment of the alkaline liquors from the digesting (pulping) of pine wood. Tall oil is derived from the spent black liquor from the pulping process which is concentrated until the sodium salts (soaps) of the various acids separate out and are skimmed off. These sodium salts of the acids are acidified with sulfuric acid. The composition and properties vary widely but average 35-40% rosin acids and 50-60% fatty acids (such as oleic and linoleic acids). Long chain alcohols and small amounts of sterols, especially phytosterol. have also been found. Tall oil is a dark brown liquid having an acrid odor similar to that of burnt rosin.

Abietic acid, [1R-(1α, 4aβ, 4bα,10 aα)]-1,2,3,4,4a,4b,5,6,10,a-decahydro-1,4a dimethyl-7-(1-methylethyl)-1-phenanthrenecarboxylic acid, 13-isopropylpodocarpa-7,13-dien-15-oic acid, has a molecular weight of 302.44 and is prepared by isomerization of rosin. Abietic acid may be represented by the formula:

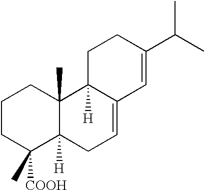

Isomeric mixtures of abietic acid may also be employed.

In Formula (1), n is an integer from 1 to about 4, preferably from 2 to 3.

Reactive tackifiers having the formula (1) and suitable for use in the present invention are commercially available under the trade name of Reagem®, manufactured by Les Derives Resiniques Et Terpeniques, France. Reagem® tackifiers are polyester tackifying resins that can tackify polyurethane. After being crosslinked with isocyanate, the Reageme tackifier becomes integrated into the polymeric network. Preferred reactive tackifiers that may be employed in the present invention are Reagem® 4020 and Reagem® 5110.

Components (a), (b), and (c) are used in amounts effective to provide a hot melt adhesive or sealant composition having the desired heat and tensile properties. The exact amount of the hot melt component is a matter of preference subject to such factors as the exact type of components selected, the type of properties desired in the final product, as well as the other ingredients in the composition. Suitable proportions of the three components in the hot melt adhesive or sealant composition of the present invention may be as follows: (a) urethane prepolymer from about 10% to about 95%; (b) polyester resin from about 5% to about 60%; and (c) reactive tackifier from about 2% to about 60%. Preferably, the components in the hot melt adhesive or sealant composition of the present invention are as follows: (a) urethane prepolymer from about 15% to about 90%; (b) polyester resin from about 5% to about 50%; and (c) reactive tackifier from about 5% to about 50%. More preferably, the components in the hot melt adhesive or sealant composition of the present invention are as follows: (a) urethane prepolymer from about 20% to about 85%; (b) polyester resin from about 10% to about 40%; and (c) reactive tackifier from about 5% to about 40%. Most preferably, the components in the hot melt adhesive or sealant composition of the present invention are as follows: (a) urethane prepolymer from about 25% to about 80%; (b) polyester resin from about 10% to about 30%; and (c) reactive tackifier from about 10% to about 30%.

In a preferred embodiment, the hot melt polyurethane adhesive or sealant compositions of the present invention further comprise a polymer formed from ethylenically unsaturated monomers. The polymer preferably has a number average molecular weight from about 2,000 to about 35,000 and is selected from the group consisting of C₁ to C₁₂ esters of acrylic acid and methacrylic acids, vinyl esters, vinyl ethers, fumarates, maleates, styrene, and acrylonitrile. The polymer contains no sulfide functionality. Preferably, the polymer is formed from ethylenically unsaturated monomers selected from the group consisting of C₁ to C₁₂ esters of acrylic acid and methacrylic acids, vinyl esters, vinyl ethers, fumarates, maleates, styrene, and acrylonitrile. Preferably, the polymer has a Tg from about −48° C. to about 105° C., more preferably from about −15° C. to about 85° C. Preferably, the polymer has a number average molecular weight less than about 20,000. Most commonly employed are substituted C₁ to C₁₂ esters of acrylic and methacrylic acids including, but not limited to substituted methyl acrylate, ethyl acrylate, n-butylacrylate, 2-ethylhexyl acrylate, isobutyl acrylate, n-propyl acrylate, and isopropyl acrylate, and the corresponding methacrylates. Mixtures of compatible (meth)acrylate monomers may also be used. Additional monomers that may be used include substituted vinyl esters (vinyl acetate and vinyl propionate), vinyl ethers, fumarates, maleates, styrene, acrylonitrile, etc. as well as comonomers thereof.

If used as monomers, these monomers are blended with other copolymerizable comonomers and formulated so as to have a wide range of Tg values, such as between about −48° C. and about 105° C., preferably between about −15° C. and about 85° C. Suitable comonomers include the C₁ to C₁₂ esters of acrylic and methacrylic acids including, but not limited to methyl acrylate, ethyl acrylate, n-butyl acrylate, isobutyl acrylate, 2-ethylhexyl acrylate, n-propyl or iso-propyl acrylate, and the corresponding methacrylates. Mixtures of compatible (meth)acrylate monomers may also be used. Additional monomers that may be used include the vinyl esters (vinyl acetate and vinyl propionate), vinyl ethers, fumarates, maleates, styrene, acrylonitrile, ethylene, etc., as well as comonomers thereof. The choice of the particular monomer(s) is largely dependent upon the desired end use of the adhesives. For example, one skilled in the art would recognize that selection of certain monomers will produce a pressure sensitive adhesive, while other monomers will give a non-pressure sensitive material. Similarly, appropriate monomers may be selected to formulate structural adhesives, conductive adhesives, etc.

Suitable proportions of the polymer formed from ethylenically unsaturated monomers in the hot melt adhesive or sealant compositions of the present invention are as follows: polymer formed from ethylenically unsaturated monomers from about 2% to about 90%; preferably, from about 5% to about 80%; more preferably, from about 8% to about 70%; and most preferably, from about 10% to about 65%

In a preferred embodiment, the invention is directed to a hot melt polyurethane adhesive or sealant composition, which is solid at room temperature, comprises, in percentages by weight of the polyurethane composition (a) from about 10% to about 95% of a urethane prepolymer having an isocyanate content from about 0.25% to about 25%, and an isocyanate index greater than 1 and up to about 5; (b) from about 2% to about 90% of a polymer formed from ethylenically unsaturated monomers, the polymer having a number average molecular weight from about 2,000 to about 35,000 and selected from the group consisting of C₁ to C₁₂ esters of acrylic acid and methacrylic acids, vinyl esters, vinyl ethers, fumarates, maleates, styrene, acrylonitrile, ethylene acrylate copolymers, ethylene butylacrylate copolymers, and ethylene vinylacetate/ethylene acrylate terpolymers, wherein the ethylene vinylacetate/ethylene acrylate terpolymers have an ethylene content from about 10% to about 55%, the polymer containing no sulfide functionality; (c) from about 5% to about 60% of a polyester resin; and (d) from about 2% to about 60% of a reactive tackifier represented by the formula:

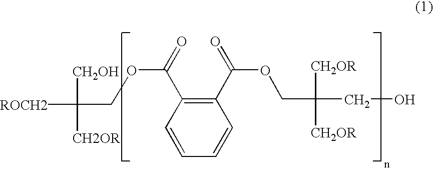

wherein R is selected from the group consisting of tall oils, abietic acid, isomeric mixtures of abietic acid, and mixtures thereof, and n is an integer from 1 to about 4.

Foamed hot melt adhesive or sealant compositions are also contemplated for use using conventional chemical or mechanical foaming techniques, with or without the use of accelerators using procedures such as are disclosed in U.S. Pat. Nos. 4,059,466; 4,059,714; 4,156,754; 4,259,402; 4,679,710; 4,601,427; 4,535,919; 4,405,063; 4,371,096; 4,264,214; and 4,200,207. A typical process for foaming comprises melting a reactive polyurethane adhesive in a heated reservoir; pumping the adhesive from the heated reservoir into a heated melt foaming device; foaming the adhesive by injecting therein an effective amount of an anhydrous gas; discharging a portion of the foamed adhesive through an orifice onto a substrate to be bonded. Foaming units which may be used to practice the invention are commercially available, e.g., Nordsons Foam Mix® and Nordsons Foam Melt®.

More specifically, the hot melt adhesive is charged into the melting reservoir of the foam melting device and heated to from about 75° to about 175° C. in order to keep the adhesive molten. The molten adhesive is then pumped from the melting reservoir into the foaming unit where the material is also maintained at a temperature of 75° to 175° C., preferably 100° to 150° C. While in the foaming unit, the adhesive is passed through a foaming pump where inert gas is injected at a pressure between 1 and 15 psi, preferably 3 to 8 psi, in an amount and at a rate sufficient to reduce the adhesive density by about 10% to about 70%, preferably about 25% to about 75%. The foamed adhesive is then extruded from the foaming unit through a heated dispenser orifice where it is applied to the substrate to be bonded.

The hot melt adhesive or sealant composition of the present invention may further comprise additional tackifying resins (tackifiers). Tackifying resins are useful in modifying many different types of adhesives. The tackifiers should have good miscibility with the urethane prepolymer. They should have a softening point at 40° C. to 130° C., are solid at about 20° C., should have high tackiness, impart high cohesive force at temperatures below about 60° C., and high instant adhesive strength.

Useful tackifiers include abietic acid and pimaric acid, which are modified by heating to induce disproportionation, by reaction with alcohols to provide esterified products, and by reaction with various catalysts to hydrogenate or polymerize the material; aromatic resins such as coumarone-indene resins; chemicals such as indene or methylindene polymerized with styrene or methylstyrene to provide aromatic tackifying resins; and aliphatic hydrocarbon tackifying resins obtained by polymerizing cis- and trans-1,3-pentadiene, and isoprene and dicylopentadiene.

The hot melt adhesive or sealant composition may further comprise a rosin or rosin derivative tackifier which is esterified, hydrogenated, maleated, formaldehyde adducted, and/or phenolated. The hot melt adhesive or sealant composition may also further comprise a rosin or rosin derivative tackifier which is an alkyl or terpene phenol. The hot melt adhesive or sealant composition may still further comprise a styrenic copolymer tackifier selected from the group consisting of styrene, styrene phenol, α-methylstyrene, vinyl toluene, methoxystyrene, tertiary butyl styrene, and chlorostyrene. Sucrose benzoate is also useful.

Useful tackifiers include terpene-phenol copolymers having a molar ratio of terpene to phenol of 1.0-3.0 or abietic acid type rosins whose active hydrogens or double bonds are removed by esterification etc., in whole or in part; such as hydrogenated rosin, hydrogenated rosin glycerine ester, hydrogenated rosin pentaerythritol, disproportionated rosin, polymerized rosin, etc. The preferred terpenes are monoterpenes having 10 carbon atoms such as α-pinene, β-pinene, camphene, myrcene, dipentene, β-phellandrene, sabinene, ocimene, α-terpinene and hydrogenated compounds thereof. When the preferred α-pinene is used, optimum properties are imparted in the form of miscibility, pot-life and initial and final adhesive strength. Diterpene analogs of the above monoterpenes having 20 carbon atoms are also useful.

When the adhesive is to be prepared utilizing monomeric materials, the respective monomers may be added to the polyols and polymerized therein prior to formation of the prepolymer or may be added to the already formed prepolymer and the acrylic polymerization subsequently performed. In the case of polyamino or polymercapto containing prepolymers, in-situ vinylic polymerization must be performed only in the pre-formed prepolymer. In this embodiment, when the urethane prepolymer is prepared from the condensation polymerization of a polyisocyanate and a polyol, the polyol may be the ethylene vinylacetate/ethylene acrylate terpolymer.

The ethylenically unsaturated monomer is polymerized using conventional free radical polymerization procedures to a relatively low molecular weight. For purposes of clarification herein, by “low molecular weight” we mean number average molecular weights in the range from about 2,000 to about 25,000, preferably about 12,000. Molecular weight distribution is characterized by Gel Permeation Chromatography using a PL Gel Mixed 10 micron column, a Shimadzu Model RID 6A Detector with a tetrahydrofuran carrier solvent at a flow rate of 1 milliliter per minute. The low molecular weight is obtained by careful monitoring and controlling the reaction conditions and, generally, by carrying out the reaction in the presence of a chain transfer agent such as dodecyl mercaptan. Subsequent to the polymerization of the ethylenically unsaturated monomer(s), the polyisocyanate and any additional ingredients required for the urethane prepolymer forming reaction are added and that reaction is carried out using conventional condensation polymerization procedures. In this manner, the resultant isocyanate terminated urethane prepolymer forms the reactive curing hot melt adhesive described above which contains about 10 to 70% of the urethane prepolymer and 30 to 90% of the acrylic polymer.

It is also possible, but not required, to polymerize the low molecular weight polymer in the presence of the already formed isocyanate terminated urethane prepolymer.

Optionally, the ethylenically unsaturated monomer may be introduced into the adhesive in the form of pre-polymerized low molecular weight hydroxyl containing polymers. In the latter case, typical polymers include unsubstituted and hydroxyl substituted butyl acrylate, unsubstituted and hydroxylated butyl acrylate/methyl methacrylate copolymers, unsubstituted and hydroxylated ethyl acrylate/methyl methacrylate copolymers, and the like, the polymers having a number average molecular weight from about 4,000 to about 2,000 and a hydroxyl number from about 5 to about 15. If used in the form of low molecular weight polymers, the polymers may be blended with the polyol prior to reaction thereof with the isocyanate or they may be added directly to the isocyanate terminated prepolymer.

The resulting hot melt adhesive compositions of the present invention are typically applied at temperatures of about 60° C. and a corresponding melt viscosity of from about 3,000 to 70,000 centipoises.

The precise formulation of the polyurethane adhesive or sealant composition of the present invention will vary depending upon the specific end use. Other ingredients may also be incorporated into the adhesive or sealant composition as dictated by the nature of the desired composition as well known by those having ordinary skill in the art. While the adhesive or sealant compositions may be used directly as described above, if desired the adhesive or sealant compositions of the present invention may also be formulated with conventional additives such as plasticizers, compatible tackifiers, catalysts, fillers, anti-oxidants, pigments, mercapto/silane adhesion promoters, stabilizers, foaming agents, and the like. The adhesive or sealant compositions are readily prepared using methods generally known in the arts.

The resulting adhesive or sealant compositions, when appropriately formulated, may be used as hot melt adhesives in virtually any packaging application in which adhesive or sealant compositions are commonly employed with a substrate, including case and carton forming and sealing, tube winding, bag manufacture, glued lap, paper and flexible film laminating. The substrates will have applied to a portion thereof the adhesive composition. Depending on the particular application, the substrate may have substantially all of one surface coated, or may be coated on two sides. Alternately, the adhesive or sealant composition may be applied as a bead, whereby a minor portion of the substrate has applied thereto the adhesive. One skilled in the art, having the knowledge of the present specification, will readily ascertain those applications in which the use of the inventive adhesive or sealant compositions would be advantageous. Any conventional method of applying the adhesive or sealants to the particular substrates may be employed. These methods are well known in the field of adhesives or sealants.

Throughout this application, various publications have been referenced. The disclosures in these publications are incorporated herein by reference in order to more fully describe the state of the art.

The present invention can be further illustrated by the following examples of preferred embodiments thereof, although it will be understood that these examples are included merely for purposes of illustration and are not intended to limit the scope of the invention unless otherwise specifically indicated.

### EXAMPLE

In these Examples, the test procedures were used.

Test Procedures

Molecular Weight—Condition of GPC Characterization

Model: Water Model 712 Wisp Autosampler

Column: PL Gel, Mixed 10 u

Detector: Shimadzu Model RID 6A

Injection Volume: 50 μUL

Flow Rate: 1 ml/minute

Temperature: 25° C.

Solvent: Tetrahydrofuran

Calibration: Polystyrene Standard

Sample Conc. 10 mg/4 ml

Open Time (Bond Range)

Coated 5 mil adhesive on the flat surface and measured the number of minutes during which the adhesive surface remained tacky.

Dynamic Peel

Coated 5 mil thickness adhesive on a hot (125° C.) glass surface. Then quickly placed a vinyl strip (325 mm×16mm×0.007 inch) in the center of adhesive film. A 103 gram weight was placed onto the hole-punched end of the vinyl strip. Under ambient conditions the temperature of the bonded composite falls. At one minute intervals, the temperature is recorded as is the length of dislocatation of the ruptured bond.

Lapshear Development Test

High Pressure Laminate (HPL) samples and particle boards were glued with a 5 mil thickness of the tested adhesives. The lap shear samples were then pulled with an Instron with a 0.5 in/min. crosshead speed at different times after the samples were prepared.

Viscosity at Melting

Viscosity of melted adhesive composition was measured by using a Brookfield Viscosmeter with No. 27 spindle at 120° C.

Open Time Studies

The procedure of the open time measurement is described as the following:

1) The 4-mil thickness of polyurethane resin adhesive was cast on Kraft paper.

2) Several tested Kraft paper strips with the size of ½″×3″ were put on the surface of the cast adhesive with very light pressure for the different period time after adhesive was cast. The bond area was ½″×1″.

3) The Kraft paper strips should be continuing to put on the surface of adhesive until the tackiness of the cast RHM was completely gone.

4) After adhesive cool down to room temperature, ripped off paper strips from glue line.

5) The open time was recorded when the bond area of Kraft paper had 50% of adhesive failure.

### EXAMPLE 1

Based on the formulation of Sample 1 (Control), two systems, Samples 2A and 2B and Samples 3A and 3B, were prepared with the following modifications. Reagem® 4020 was added to Samples 2A and 3A and Reagem® 5110 was added to Samples 2B and 3B. Dynacoll 7360 (hexanediol adipate, Creanova Company) was present in Samples 3A and 3B but was 7360 was not added to the formulations of Samples 2A and 2B. The compositions of Sample 1 (Control), Samples 2A and 2B and Samples 3A and 3B are shown in Table 1.

TABLE 1

| | Sample 1 | Sample 2A | Sample 2B | Sample 3A | Sample 3B |
|---|---|---|---|---|---|
| PPG 2025 | 19.5 | 19.5 | 19.5 | 19.5 | 19.5 |
| PPG4025 | 19.5 | 19.5 | 19.5 | 19.5 | 19.5 |
| Dynacoll 7360 | 19.5 | — | — | 19.5 | 19.5 |
| Elvacite 2016 | 28.0 | 28.0 | 28.0 | 28.0 | 28.0 |
| DMDEE | 0.1 | 0.1 | 0.1 | 0.1 | 111 0.1 |
| MDI | 12.6 | 12.6 | 12.6 | 12.6 | 12.6 |
| Reagem ® 4020 | — | 19.5 | — | 19.5 | — |
| Reagem ® 5110 | — | — | 19.5 | — | 19.5 |

PPG = polypropylene glycol
Dynacoll 7360 = hexanediol adipate, a polyester diol
Elvacite 2016 = a copolymer of methyl methacrylate and butyl methacrylate
DMDEE = 2,2'-dimorpholinodiethyl ether
MDI = methylene di-para-phenylene isocyanate
Reagem 4020 and 5110 = reactive tackifier of the formula 1

Dynamic Peel Values for the samples are shown in Table 2 and Lap Shear Strength Development for the samples is shown in Table 2.

TABLE 2
Dynamic Peel Values

| Temperature | 55° C. | 50° C. | 40° C. | 30° C. |
|---|---|---|---|---|
| Sample 1 | 582 mm/min | 285 mm/min | 50 mm/min | 14 mm/min |
| Sample 2A | 270 mm/min | 105 mm/min | 27 mm/min | 9 mm/min |
| Sample 2B | 124 mm/min | 56 mm/min | 10 mm/min | 2 mm/min |
| Sample 3A | 480 mm/min | 207 mm/min | 32 mm/min | 13 mm/min |
| Sample 3B | 223 mm/min | 132 mm/min | 28 mm/min | 6 mm/min |

TABLE 3
Lap Shear Strength Development

| Time | 30 min. | 2 hr. | 4 hr. | 24 hr. |
|---|---|---|---|---|
| Sample 1 | 54 psi | 313 psi | 375 psi | 438 psi |
| Sample 2A | 20 psi | 92 psi | 19 psi | 276 psi |
| Sample 2B | 43 psi | 98 psi | 218 psi | 277 psi |
| Sample 3A | 156 psi | 409 psi | 442 psi | 448 psi |
| Sample 3B | 25 psi | 241 psi | 462 psi | 446 psi |

The uncured physical properties of the Samples 2A, 2B, 3A and 3B are shown in Table 4.

TABLE 4

| Sample # | Sample 1 | Sample 2A | Sample 2B | Sample 3A | Sample 3B |
|---|---|---|---|---|---|
| % Free NCO | 2.1 | 2.3 | 2.3 | 2.1 | 2.0 |
| Viscosity (cps) | 11,500 | 5,200 | 9,100 | 8,400 | 10,500 |
| Stability | 2.6 | 10.5 | 3.3 | 9.8 | 0.0 |
| (% rise/hr.) | | | | | |
| Open Time | 7 | 50.0 | 45.0 | 25.0 | 35.0 |
| (min.) | | | | | |

These studies revealed that polyurethane resin hot melt adhesives with Reagem® functional tackifiers showed much longer open time and stronger initial strength than conventional polyurethane resin hot melt products

### EXAMPLE 2

In order to compare the properties of reactive hot melt adhesives with different functional tackifiers, several samples were prepared. Samples 4A-7A had the same formulations as Samples 2A and 2B (without Dynacoll 7360) and Samples 4B-7B had the same formulations as Samples 3A and 3B (with Dynacoll 7360) except that the functional tackifiers were replaced by different tackifiers, that is XR 4008, RH 97 M-NC, RH 200-NC, and KE-615-3. The compositions of Samples 4A-7A are shown in Table 5 and the compositions of Samples 4B-7B are shown in Table 6.

TABLE 5

| | Sample 4A | Sample 5A | Sample 6A | Sample 7A |
|---|---|---|---|---|
| PPG 2025 | 19.5 | 19.5 | 19.5 | 19.5 |
| PPG4025 | 19.5 | 19.5 | 19.5 | 19.5 |
| Elvacite 2016 | 28.0 | 28.0 | 28.0 | 28.0 |
| DMDEE | 0.1 | 0.1 | 0.1 | 0.1 |
| MDI | 12.6 | 12.6 | 12.6 | 12.6 |
| XR 4008 | 19.5 | — | — | — |
| RH 97M-NC | — | 19.5 | — | — |
| RH 200-NC | — | — | 19.5 | — |
| KE 615-3 | — | — | — | 19.5 |

XR 4008 is an ester of rosin acid and bisphenol
RH 97M-NC is a rosin ester base with pentaerythritol adipate
RH 200-NC is a rosin ester base with glycerol ester adipate
KE 615-3 is a hydrogenated rosin ester

TABLE 6

| | Sample 4B | Sample 5B | Sample 6B | Sample 7B |
|---|---|---|---|---|
| PPG 2025 | 19.5 | 19.5 | 19.5 | 19.5 |
| PPG4025 | 19.5 | 19.5 | 19.5 | 19.5 |
| Dynacoll 7360 | 19.5 | 19.5 | 19.5 | 19.5 |
| Elvacite 2016 | 28.0 | 28.0 | 28.0 | 28.0 |
| DMDEE | 0.1 | 0.1 | 0.1 | 0.1 |
| MDI | 12.6 | 12.6 | 12.6 | 12.6 |
| XR 4008 | 19.5 | — | — | — |
| RH 97M-NC | — | 19.5 | — | — |
| RH 200-NC | — | — | 19.5 | — |
| KE 615-3 | — | — | — | 19.5 |

Dynamic peel values for the samples are shown Table 7 and the lap shear strength development for the samples are shown in Table 8.

TABLE 7
Dynamic Peel Values

| Temperature | 55° C. | 50° C. | 40° C. | 30° C. |
|---|---|---|---|---|
| Sample 1 | 582 mm/min | 285 mm/min | 50 mm/min | 14 mm/min |
| Sample 4A | 58 mm/min | 34 mm/min | 9 mm/min | 0 mm/min |
| Sample 5A | 211 mm/min | 158 mm/min | 71 mm/min | 22 mm/min |
| Sample 6A | 302 mm/min | 209 mm/min | 82 mm/min | 27 mm/min |
| Sample 7A | 642 mm/min | 350 mm/min | 113 mm/min | 46 mm/min |
| Sample 4B | 96 mm/min | 48 mm/min | 12 mm/min | 0 mm/min |
| Sample 5B | 203 mm/min | 97 mm/min | 14 mm/min | 5 mm/min |
| Sample 6B | 404 mm/min | 253 mm/min | 98 mm/min | 21 mm/min |
| Sample 7B | 355 mm/min | 252 mm/min | 73 mm/min | 32 mm/min |

TABLE 8
Lap Shear Strength Development

| Time | 30 min. | 2 hr. | 4 hr. | 24 hr. |
|---|---|---|---|---|
| Sample 1 | 54 psi | 313 psi | 375 psi | 438 psi |
| Sample 4A | 51 psi | 147 psi | 382 psi | 377 psi |
| Sample 5A | 43 psi | 98 psi | 218 psi | 345 psi |
| Sample 6A | 10 psi | 24 psi | 108 psi | 329 psi |
| Sample 7A | 12 psi | 38 psi | 178 psi | 365 psi |
| Sample 4B | 31 psi | 154 psi | 306 psi | 387 psi |
| Sample 5B | 9 psi | 169 psi | 402 psi | 487 psi |
| Sample 6B | 15 psi | 146 psi | 400 psi | 482 psi |
| Sample 7B | 25 psi | 108 psi | 282 psi | 516 psi |

The uncured physical properties of polyurethane resin hot melt adhesives without Dynacoll 7360 are shown in Table 9 and the uncured physical properties of polyurethane resin hot melt adhesives with Dynacoll 7360 are shown Table 10.

TABLE 9

| Sample # | Sample 4A | Sample 5A | Sample 6A | Sample 7A |
|---|---|---|---|---|
| % Free NCO | 1.7 | 3.1 | 3.5 | 3.3 |
| Viscosity (cps) | 15,000 | 7,900 | 7,900 | 4,400 |
| Stability | 6.7 | 4.4 | 7.9 | 2.8 |
| (% rise/hr.) | | | | |
| Open Time | 9.0 | 17.0 | 35.0 | 40.0 |
| (min.) | | | | |

TABLE 10

| Sample # | Sample 4B | Sample 5B | Sample 6B | Sample 7B |
|---|---|---|---|---|
| % Free NCO | 2.2 | 2.2 | 2.4 | 2.7 |
| Viscosity (cps) | 37,000 | 15,400 | 14,500 | 10,500 |
| Stability | 6.3 | 9.8 | 6.0 | 6.9 |
| (% rise/hr.) | | | | |
| Open Time | 9.0 | 30.0 | 30.0 | 40.0 |
| (min.) | | | | |

Examples 1 and 2 show that reactive hot melt adhesives containing a functional tackifier, Reagem® 4020 or 5110, with polyester diol could improve dynamic peel property and lap shear strength development speed. The melt viscosity of new formulated adhesives were reduced and open time was increased. The combination of Reagem® tackifiers with polyester diol and acrylic copolymer provide unique properties for reactive hot melt adhesive products.

### EXAMPLE 3

This examples shows that functional tackifiers (Reagem® 4020 and 5110) with polyester diol can provide lower viscosity, longer open time, and higher initial strength for reactive hot melt adhesives. The effect of plastic on the physical properties of reactive hot melt adhesive with Reagem was studied. Elvacite (acrylic copolymer, methyl methacrylate/ ethyl methacrylate) was selected for this evaluation.

The formulations for this Example (Samples 10A-10E) are listed in Table 11.

TABLE 11

| Sample Number | 10A | 10B | 10C | 10D | 10E |
|---|---|---|---|---|---|
| PPG-2025 | 19.8 | 19.8 | 19.8 | 19.8 | 19.8 |
| PPG-4025 | 19.8 | 19.8 | 19.8 | 19.8 | 19.8 |
| Dynacoll 7360 | 19.8 | 19.8 | 19.8 | 19.8 | 19.8 |
| Elvacite 2016 | 28.3 | 28.3 | — | — | — |
| Reagem ® 4020 | 19.8 | — | 19.8 | — | — |
| Reagem ® 5110 | — | 19.8 | — | 19.8 | — |
| DMDEE | 0.2 | 0.2 | 0.2 | 0.2 | 0.2 |
| MDI | 18.0 | 18.0 | 16.0 | 16.0 | 10.5% |
| NCO | 2.3 | 2.0 | 2.3 | 2.5 | 1.9 |
| Viscosity (cps) @ | 9,000 | 8,875 | 1,820 | 1,360 | 600 |
| 250° F. | | | | | |
| Stability | 5.0% | 6.5% | 9.5% | 7.2% | 15.0% |

Dynamic peel values for the samples are shown in Table 12 and lap shear strength development for the samples are shown in Table 13.

TABLE 12
Dynamic Peel Values

| Temperature | 55° C. | 50° C. | 40° C. | 30° C. |
|---|---|---|---|---|
| Sample 10A | 208 mm/min | 121 mm/min | 28 mm/min | 2 mm/min |
| Sample 10B | 92 mm/min | 48 mm/min | 14 mm/min | 1 mm/min |
| Sample 10C | — mm/min | 503 mm/min | 125 mm/min | 23 mm/min |
| Sample 10D | — mm/min | — mm/min | — mm/min | 172 mm/min |
| Sample 10E | — mm/min | — mm/min | — mm/min | — mm/min |

TABLE 13
Lap Shear Strength Development

| Time | 30 min. | 2 hr. | 4 hr. | 24 hr. |
|---|---|---|---|---|
| Sample 10A | 132 psi | 316 psi | 436 psi | 425 psi |
| Sample 10B | 63 psi | 240 psi | 407 psi | 436 psi |
| Sample 10C | 14 psi | 206 psi | 308 psi | 327 psi |
| Sample 10D | 10 psi | 81 psi | 174 psi | 212 psi |
| Sample 10E | 6 psi | 58 psi | 97 psi | 102 psi |

The dynamic peel data shows that Sample 10E, which did not contain plastic and functional tackifier, had a very weak dynamic peel property. When functional tackifiers were added, the initial strength of two samples, Sample 10C and 10D, were improved significantly. However, the additional plastic content pushed the initial strength even better. The data showed that the initial strengths of Sample 10A and 10B were better than control Sample 1.

Without functional tackifiers and plastic, the lap shear strength of Sample 10E was very weak. With tackifiers only, the lap shear of Sample 10C and 10D was increased, but the final cured strength and the strength development speed were weaker and slower than control Sample 1. Sample 10A and 10B showed a good balance of excellent mechanical strength and fast lap shear development speed.

The Examples show that Reagem® 5110 and 4020 reactive tackifiers provide unique properties for reactive hot melt application. When these particular functional tackifiers are mixed with polyester diol and plastic, the formulated products show an excellent balance of open time, melt viscosity, initial strength, and final cured strength.

While a number of embodiments of this invention have been represented, it is apparent that the basic construction can be altered to provide other embodiments which utilize the invention without departing from the spirit and scope of the invention. All such modifications and variations are intended to be included within the scope of the invention as defined in the appended claims rather than the specific embodiments which have been presented by way of example.

We claim:

1. A moisture curable hot melt polyurethane adhesive or sealant composition comprising:
(a) a urethane prepolymer;
(b) a polyester resin; and
(c) a reactive tackifier represented by the formula: 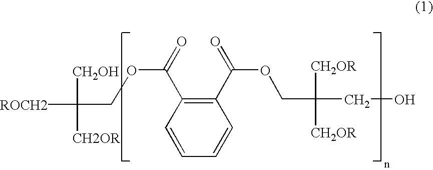
wherein R is selected from the group consisting of tall oils, abietic acid, isomeric mixtures of abietic acid, and mixtures thereof, and n is an integer from 1 to about 4.

2. The composition according to claim 1, wherein the urethane prepolymer (a) is prepared from the condensation polymerization of a polyisocyanate and a polyol, is present in an amount from about 10% to about 95%, has an isocyanate content from about 0.25% to about 25%, and has an isocyanate index greater than 1 and up to about 5, in percentages by weight of the polyurethane composition.

3. The composition according to claim 2, wherein the urethane prepolymer (a) is prepared from a polyisocyanate selected from the group consisting of ethylene diisocyanate; ethylidene diisocyanate; propylene diisocyanate; 3-isocyanatomethyl-3,5,5-trimethylcyclohexyl isocyanate; 3-isocyanatomethyl-3,5,5-trimethylcyclohexyl isocyanate cyanurate; butylene diisocyanate; hexamethylene diisocyanate; toluene diisocyanate; cyclopentylene-1,3,-diisocyanate; cyclohexylene-1,4-diisocyanate; cyclohexylene-1,2-diisocyanate; 4,4′-diphenylmethane diisocyanate; 2,2-diphenylpropane-4,4′-diisocyanate; p-phenylene diisocyanate; m-phenylene diisocyanate; xylylene diisocyanate; 1,4-naphthylene diisocyanate; 1,5-naphthylene diisocyanate; diphenyl-4,4′-diisocyanate; azobenzene-4,4′-diisocyanate; diphenylsulphone-4,4′-diisocyanate; dichlorohexamethylene diisocyanate; furfurylidene diisocyanate; 1-chlorobenzene-2,4-diisocyanate; 4,4′,4″-triisocyanatotriphenylmethane; 1,3,5-triisocyanato-benzene; 2,4,6-triisocyanato-toluene; and 4,4′-dimethyldiphenylmethane-2,2′,5,5-tetraisocyanate.

4. The composition according to claim 2, wherein the urethane prepolymer (a) is prepared from a polyol selected from the group consisting of polyalkylene ether glycols, polyhydroxy polyalkylene ethers, polyhydroxy polyesters, ethylene and propylene oxide adducts of polyols, and esters of glycerol.

5. The composition according to claim 1, wherein the polyester resin (b) is a polycondensation product of a C₄-C₁₂ dicarboxylic acid and a C₆-C₁₂ dihydroxy alcohol, and is present in an amount from about 5% to about 60%, in percentages by weight of the polyurethane composition.

6. The composition according to claim 5, wherein the C₄-C₁₂ dicarboxylic acid is selected from the group consisting of adipic acid, maleic acid, fumaric acid, phthalic acid, isophthalic acid, and terephthalic acid and the C₆-C₁₂ dihydroxy alcohol is selected from the group consisting of ethylene glycol, propylene glycol, diethylene glycol, dipropylene glycol, hexamethylene glycol, and dodecanediol.

7. The composition according to claim 1, wherein the reactive tackifier (c) is present in an amount from about 2% to about 60%, in percentages by weight of the polyurethane composition.

8. The composition according to claim 1, wherein R in the reactive tackifier (c) is tall oil.

9. The composition according to claim 1, wherein R in the reactive tackifier (c) is abietic acid.

10. The composition according to claim 1, wherein R in the reactive tackifier (c) is am isomeric mixture of abietic acid.

11. The composition according to claim 1, wherein the reactive tackifier (c) is Reagem® 4020.

12. The composition according to claim 1, wherein the reactive tackifier (c) is Reagem® 5110.

13. The composition according to claim 1, wherein the urethane prepolymer (a) is present in an amount from about 15% to about 90%.

14. The composition according to claim 1, wherein the polyester resin (b) is present in an amount from about 5% to about 50%.

15. The composition according to claim 1, wherein the reactive tackifier (c) is present in an amount from about 5% to about 50%.

16. The composition according to claim 1, further comprising a polymer formed from ethylenically unsaturated monomers.

17. The composition according to claim 16, wherein the polymer formed from ethylenically unsaturated monomers is present in an amount from about 2% to about 90%, has a number average molecular weight from about 2,000 to about 35,000, and is selected from the group consisting of C₁ to C₁₂ esters of acrylic acid and methacrylic acids, vinyl esters, vinyl ethers, fumarates, maleates, styrene, acrylonitrile, ethylene acrylate copolymers, ethylene butylacrylate copolymers, and ethylene vinylacetate/ethylene acrylate terpolymers; wherein the ethylene vinylacetate/ethylene acrylate terpolymers have an ethylene content from about 10% to about 55%, the polymer containing no sulfide functionality, in percentages by weight of the polyurethane composition.

18. The composition according to claim 17, wherein the polymer is a polymer formed from ethylenically unsaturated monomers selected from the group consisting of C₁ to C₁₂ esters of acrylic acid and methacrylic acids, vinyl esters, vinyl ethers, fumarates, maleates, styrene, and acrylonitrile.

19. The composition according to claim 16, wherein the polymer is present in an amount from about 5% to about 80%.

20. The composition according to claim 1, wherein the composition is foamed.

21. An article of manufacture comprising the moisture curable hot melt polyurethane adhesive or sealant composition of claim 1.
